(19) United States
(12) Patent Application Publication
(10) Pub. No.: US 2007/0262607 A1
(43) Pub. Date: Nov. 15, 2007

(54) Method of assembling door parts on automobile door

(75) Inventor: Katsushi Saito, Hiroshima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Nishikawa Rubber Co., Ltd., Hiroshima-shi (JP)

(21) Appl. No.: 11/732,425

(22) Filed: Apr. 3, 2007

(30) Foreign Application Priority Data
May 12, 2006 (JP) JP2006-134500

(51) Int. Cl. B60J 1/08

(52) U.S. Cl. 296/146.2

(57) ABSTRACT

There is provided a method of assembling door parts on an automobile door, said door parts including: a glass run mounted on a roof side and a pillar side, which has a ditch part formed therein for guiding lifting or lowering of a door glass and provided with lips slidably brought into contact with the door glass; a roof molding; a pillar molding; and a belt line molding to be mounted along a belt line, comprising the steps of: connecting an upper end part of said pillar molding having said glass run mounted therein to a rear end part of said roof molding having said glass run mounted therein and connecting said belt line molding both to a front end part of said roof molding and a lower end part of said pillar molding, thereby assembling a modularized product in advance; and assembling said modularized product on the front door in a vehicle assembly line.

### BACKGROUND OF THE INVENTION

The present invention relates to a method of assembling door parts on an automobile door, and more particularly to a method of assembling door parts, including a glass run and a molding, on an automobile with a sash type door.

As shown in FIG. 20 which is a cross section of a roof side with a molding and FIG. 21 which is a cross section of a roof side without a molding, a glass run 10 for guiding lifting or lowering of a door glass 200 has been mounted to a door sash 2 of an automobile door 100.

The glass run 10 includes: a cross-section roughly U-shaped installation base member 11 consisting of an outer-cabin side wall 11a, a bottom wall 11b and an inner-cabin side wall 11c; an outer lip 12 formed inward from the outer-cabin side wall 11a of the installation base member 11; and an inner lip 13 formed outward from the inner-cabin side wall 11c of the installation base member 11. The installation base member 11 has a ditch part 20 formed therein for guiding the door glass 200, that is a space enclosed by the outer-cabin side wall 11a, the bottom wall 11b and the inner-cabin side wall 11c. The outer lip 12 and the inner lip 13 are slidably brought into contact with the door glass 200 lifting or lowering.

An ordinary method of assembling door parts on an automobile door, according to FIG. 20, has comprised the steps of: constructing a cross-section roughly U-shaped channel part 30 by assembling an exterior roof molding 31 (painted in black) on an end part of a cross-section roughly L-shaped part formed on an outer-cabin side of the door sash 2; and mounting the glass run 10 inside the channel part 30. On an outer-cabin side of the door 100, the roof molding 31 is assembled on a part 600 where an installation base member 3a of a drip seal 3, which makes an elastic contact with a body panel 300 when the door 100 is closed, is mounted. On the inner-cabin side of the door 100, a weather strip 4 is mounted, which makes an elastic contact with the body panel 300 when the door 100 is closed.

Another example of well-known method of assembling the door parts on an automobile door, according to FIG. 21, has comprised the steps of: forming a cross-section roughly U-shaped channel part 30 by bending the outer-cabin side of the door sash 2, thereby forming the channel part 30 only of the door sash 2; and mounting the glass run 10 inside the channel part 30. Such a method is disclosed, for example, in the Japanese unexamined Patent Publication No. H10-329768.

The glass run 10 according to FIG. 20 and FIG. 21 is assembled on the door sash 2 of a door panel in a vehicle assembly line.

An ordinary method of assembling the door parts on a front door has comprised the steps of assembling the glass run 10 inside the channel part 30 of the door sash 2; and tilting and inserting the door glass 200 into the door panel.

On the other hand, an ordinary method of assembling the door parts on a rear door has comprised the steps of: inserting the door glass 200 into the door panel prior to assembling the glass run 10; and forcedly inserting the glass run 10 from an upper side of the door glass 200 into the channel part 30 of the door sash 2.

As a result, said methods of assembling the door parts on the doors have required a skilled expert at the vehicle assembly line and difference in skill may influence external appearance of the parts thus assembled.

Said methods of assembling the door parts on the doors have also required collecting each of the parts from a warehouse of the assembly line side and assembling said parts respectively.

Especially, the cross section of the roof side with the molding, shown in FIG. 20, discloses formation of the cross-section roughly U-shaped channel part 30 by assembly of two members: the door sash 2; and an exterior roof molding 31 assembled on the door sash 2. Therefore, there has remained a problem that the two members are inadequately assembled when one of the two members or both of the two members are uneven.

Therefore, an object of the present invention is to provide the method of assembling the door parts on an automobile door, capable of streamlining the assembly of the door parts by modularizing the door parts.

### SUMMARY OF THE INVENTION

In order to achieve the above-mentioned object, the invention provides a method of assembling door parts on a front door with a sash (2), said door parts including: a glass run (10) mounted on a roof side and a pillar side, which has a ditch part (20) formed therein for guiding lifting or lowering of a door glass (200) and provided with lips (12, 13) slidably brought into contact with the door glass (200); a decorative roof molding (40A, 50A) covering said roof side from an outer-cabin side; a decorative pillar molding (40B, 50B) covering said pillar side from the outer-cabin side; and a decorative belt line molding (40C) to be mounted along a belt line (700), comprising the steps of: connecting an upper end part of said pillar molding (40B, 50B) having said glass run (10) mounted therein to a rear end part of said roof molding (40A, 50A) having said glass run (10) mounted therein and connecting said belt line molding (40C) both to a front end part of said roof molding (40A, 50A) and a lower end part of said pillar molding (40B, 50B), thereby assembling a modularized product (100A) in advance; and, in a vehicle assembly line, assembling said modularized product (100A) on the front door by fitting the belt line molding (40C) along the belt line (700) and the roof molding (40A, 50A) and the pillar molding (40B, 50B) along the door sash (2).

The modularized product (100A) of the present invention may be assembled on the front door prior to inserting the door glass (200) into a panel of the front door. The modularized product (100A) may also be pressed down from an upper side of the door glass (200) and assembled on the front door by fitting the roof molding (40A, 50A) and the pillar molding (40B, 50B) along the door sash (2) after inserting the door glass (200) into the door panel.

The invention also provides a method of assembling door parts on a front door with a sash (2), said door parts including: a glass run (10) mounted on a roof side and a pillar side, which has a ditch part (20) formed therein for guiding lifting or lowering of a door glass (200) and provided with lips (12,13) slidably brought into contact with the door glass (200); a decorative roof molding (40A, 50A) covering said roof side from an outer-cabin side; and a decorative pillar molding (40B, 50B) covering said pillar side from the outer-cabin side, comprising the steps of connecting an upper end part of said pillar molding (40B, 50B) having said glass run (10) mounted therein to a rear end part of said roof molding (40A, 50A) having said glass run (10) mounted therein, thereby assembling a modularized product (101A) in advance; and, in a vehicle assembly line, assembling said modularized product (101A) on the front door by fitting the roof molding (40A, 50A) and the pillar molding (40B, 50B) along the door sash (2).

The modularized product (101A) of the present invention may be assembled on the front door prior to inserting the door glass (200) into a panel of the front door. The modularized product (101A) may also be pressed down from an upper side of the door glass (200) and assembled on the front door by fitting the roof molding (40A, 50A) and the pillar molding (40B, 50B) along the door sash (2) after inserting the door glass (200) into the door panel.

The invention further provides a method of assembling door parts on a rear door with a sash (2), said door parts including: a glass run (10) mounted on a roof side and a pillar side, which has a ditch part (20) formed therein for guiding lifting or lowering of a door glass (200) and provided with lips (12,13) slidably brought into contact with the door glass (200); a decorative roof molding (40A, 50A) covering said roof side from an outer-cabin side; a decorative pillar molding (40B, 50B) covering said pillar side from the outer-cabin side; and a decorative belt line molding (40C) to be mounted along a belt line (700), comprising the steps of: connecting an upper end part of said pillar molding (40B, 50B) having said glass run (10) mounted therein to a front end part of said roof molding (40A, 50A) having said glass run (10) mounted therein, and connecting said belt line molding (40C) both to a rear end part of said roof molding (40A, 50A) and a lower end part of said pillar molding (40B, 50B), thereby assembling a modularized product (100B) in advance; and, in a vehicle assembly line, inserting the door glass (200) into a panel of said rear door, pressing down the modularized product (100B) from an upper side of the door glass (200) so as to insert an upper part of said door glass (200) into the glass run (10) on the roof side and assembling the modularized product (100B) on the rear door by fitting the belt line molding (40C) along the belt line (700) and the roof molding (40A, 50A) and the pillar molding (40B, 50B) along the door sash (2).

Furthermore, the invention provides a method of assembling door parts on a rear door with a sash (2), said door parts including: a glass run (10) mounted on a roof side and a pillar side, which has a ditch part (20) formed therein for guiding lifting or lowering of a door glass (200) and provided with lips (12,13) slidably brought into contact with the door glass (200); a decorative roof molding (40A, 50A) covering said roof side from an outer-cabin side; and a decorative pillar molding (40B, 50B) covering said pillar side from the outer-cabin side, comprising the steps of: connecting an upper end part of said pillar molding (40B, 50B) having said glass run (10) mounted therein to a front end part of said roof molding (40A, 50A) having said glass run (10) mounted therein, thereby assembling a modularized product (101B) in advance; and, in a vehicle assembly line, inserting the door glass (200) into a panel of said rear door, pressing down the modularized product (101B) from an upper side of the door glass (200) so as to insert an upper part of said door glass (200) into the glass run (10) on the roof side and assembling the modularized product (101B) on the rear door by fitting the roof molding (40A, 50A) and the pillar molding (40B, 50B) along the door sash (2).

Still further, the invention provides the method of assembling the door parts on the door, wherein: said glass run (10) includes a cross-section roughly U-shaped installation base member (11) consisting of an outer-cabin side wall (11a), a bottom wall (11b) and an inner-cabin side wall (11c); each of said roof molding (40A, 50A) and said pillar molding (40B, 50B) are integrally molded with a cross-section roughly U-shaped channel part (41, 51) having the installation base member (11) of said glass run (10) fitted therein; and, in an assembly of said modularized product (100A, 101A, 100B, 101B), said roof molding (40A, 50A) and said pillar molding (40B, 50B) are assembled on an outer-cabin side of a mounting surface (2a) of the door sash (2), which is formed roughly in parallel with a surface of the door glass (200).

Said roof molding (40A, 50A) and said pillar molding (40B, 50B) may be made of metal or resin.

A use of a roof molding (40A, 50A) and a pillar molding (40B, 50B), which are made of resin enables integral molding of the glass run (10) with each of the roof molding (40A, 50A) and the pillar molding (40B, 50B).

Symbols in parentheses show constituents or items corresponding to Figures and DESCRIPTION OF PREFERRED EMBODIMENT.

According to the method of assembling the door parts on the door of the invention, the door parts including the roof molding, the pillar molding and the belt line molding to be assembled on the front door with the sash or the rear door with the sash are assembled into the modularized product prior to the vehicle assembly line. Therefore, unevenness in any of the parts, detected in a connecting operation of the parts can be adjusted prior to the vehicle assembly line.

As a result, in the vehicle assembly line, adjustment of the unevenness in any of the parts is unnecessary so that the modularized product excellent in appearance can be easily selected and assembled on the door panel.

In addition, the assembly of the modularized product, carried out in the final vehicle assembly line enables streamlined assembly of the door parts so that even an unskilled operator can easily carry out the assembly.

Apart from said door panel, the roof molding and the pillar molding are provided as a modularized part. Therefore, an external appearance exposing part of the modularized part as a decorative surface can be freely luster painted in harmony with design of an automobile body.

As shown in FIG. 21, an ordinary method of assembling the door parts on the door, especially on the rear door, has comprised the steps of: assembling the door glass 200 in the door panel prior to assembling the glass run 10; and forcedly inserting the glass run 10 from an upper side of the door glass 200 into the channel part 30 of the door sash 2. On the other hand, according to the method of assembling the door parts on the door of the present invention, since only the assembly of the roof molding having the glass run fitted therein on the outer-cabin side of the mounting surface of the door sash is required in the vehicle assembly line in which, in the prior art, the glass run has been assembled after inserting the door glass into the door panel, an excessive force is not needed and even the unskilled operator can easily carry out the assembly.

Each of the roof molding and the pillar molding are integrally molded with the cross-section roughly U-shaped channel part having the installation base member of said glass run fitted therein. Therefore, periphery of the glass run is covered with the roof molding or the pillar molding and the glass run is firmly assembled with the roof molding or the pillar molding.

Further, the roof molding or the pillar molding can easily separate from the door sash. Therefore, the roof molding or the pillar molding can be painted, for example, on parts makers' end and the color painted on the roof molding or the pillar molding can be freely selected.

The use of a roof molding and a pillar molding, which are made of metal excellent in rigidity and weatherability results in improved durability. In addition, luster peculiar to the metal demonstrates unique decorativeness.

The use of a roof molding and a pillar molding, which are made of resin results in improved productivity as well as downsizing because the roof molding and the pillar molding, which are made of resin can be set up the same color as the glass run so that further painting is not required.

Furthermore, the integral molding of the glass run with each of the roof molding and the pillar molding results in unnecessity of assembling the glass run and the roof molding respectively or the glass run and the pillar molding respectively, thereby improving the productivity.

### BRIEF DESCRIPTION OF THE DRAWINGS

FIG. 1 is a lateral view showing a modularized product consisting of door parts to be assembled on an automobile door, according to a first embodiment of the present invention;

FIG. 2 is a I-I line enlarged cross section of FIG. 1, showing a state that the modularized product consisting of the door parts to be assembled on an automobile door, according to the first embodiment of the present invention is assembled on a door;

FIG. 3 is a II-II line enlarged cross section of FIG. 1, showing the state that the modularized product consisting of the door parts to be assembled on an automobile door, according to the first embodiment of the present invention is assembled on the door;

FIG. 4 is a III-III line enlarged cross section of FIG. 1, showing the modularized product consisting of the door parts to be assembled on an automobile door, according to the first embodiment of the present invention;

FIG. 5 is a IV-IV line enlarged cross section of FIG. 1, showing the modularized product consisting of the door parts to be assembled on an automobile door, according to the first embodiment of the present invention;

FIG. 6 is a V-V line enlarged cross section of FIG. 1, showing the modularized product consisting of the door parts to be assembled on an automobile door, according to the first embodiment of the present invention;

FIG. 7 is an enlarged cross section showing important parts concerned with assembly of the modularized product consisting of the door parts on an automobile door, according to the first embodiment of the present invention;

FIG. 8 is a lateral view showing the assembly of the modularized product consisting of the door parts on an automobile door, according to the first embodiment of the present invention;

FIG. 9 is a VI-VI line enlarged cross section of FIG. 8;

FIG. 10 is a lateral view showing a modularized product consisting of door parts to be assembled on another automobile door, according to the first embodiment of the present invention;

FIG. 11 is a VII-VII line enlarged cross section of FIG. 10;

FIG. 12 is a I-I line enlarged cross section of FIG. 1, showing a state that the modularized product consisting of the door parts to be assembled on another automobile door, according to the first embodiment of the present invention is assembled on the door;

FIG. 13 is a II-II line enlarged cross section of FIG. 1, showing the state that the modularized product consisting of the door parts to be assembled on another automobile door, according to the first embodiment of the present invention is assembled on the door;

FIG. 14 is a I-I line enlarged cross section of FIG. 1, showing a state that a modularized product consisting of door parts to be assembled on an automobile door, according to a second embodiment of the present invention is assembled on a door;

FIG. 15 is an enlarged cross section showing important parts of the door parts to be assembled on an automobile door of FIG. 14;

FIG. 16 is a II-II line enlarged cross section of FIG. 1, showing the state that the modularized product consisting of the door parts to be assembled on an automobile door, according to the second embodiment of the present invention is assembled on the door;

FIG. 17 is a I-I line enlarged cross section of FIG. 1, showing a state that the modularized product consisting of door parts to be assembled on another automobile door, according to the second embodiment of the present invention is assembled on the door;

FIG. 18 is a I-I line enlarged cross section of FIG. 1, showing a state that the modularized product consisting of the door parts to be assembled on another automobile door, according to the second embodiment of the present invention is assembled on the door;

FIG. 19 is a lateral view showing another division bar;

FIG. 20 is a cross section showing a roof side with a molding according to a prior art; and

FIG. 21 is a cross section showing a roof side without a molding according to another prior art.

### DESCRIPTION OF PREFERRED EMBODIMENT

### First Embodiment

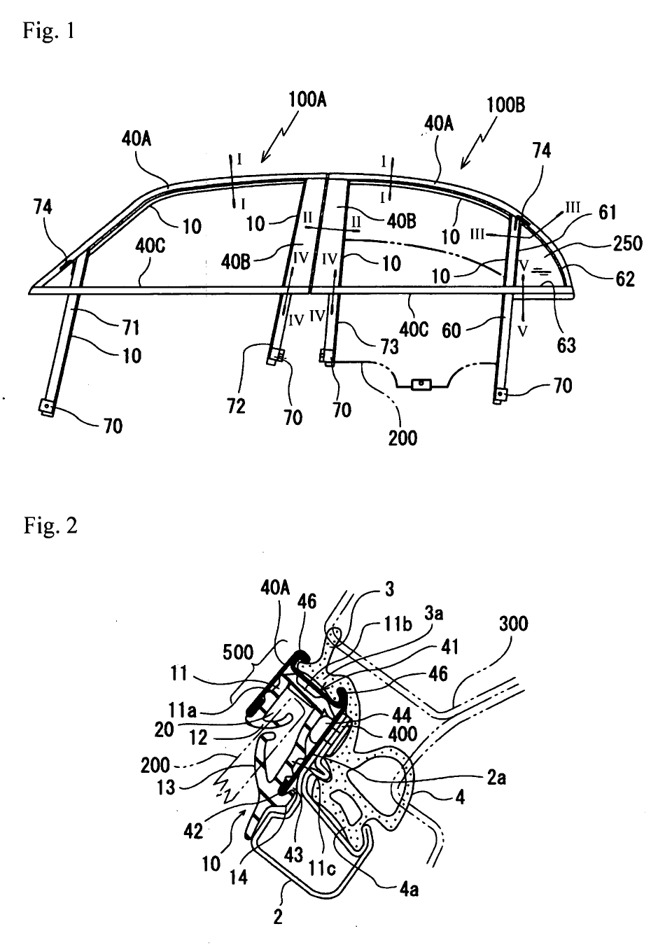

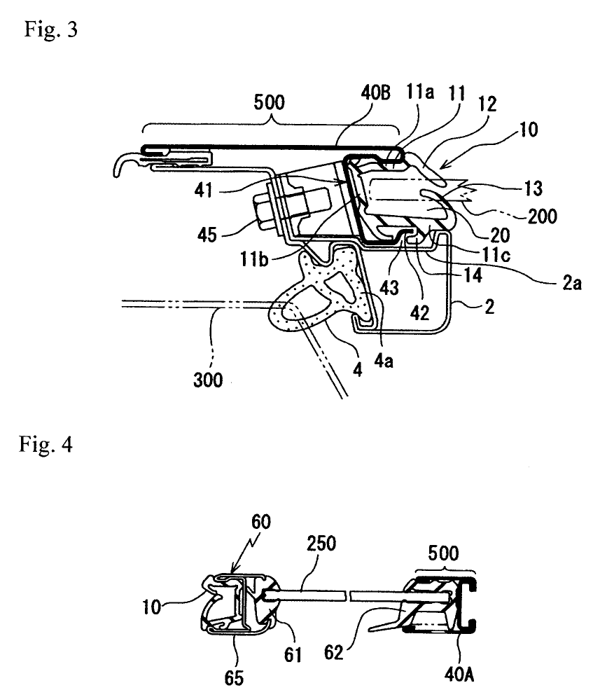

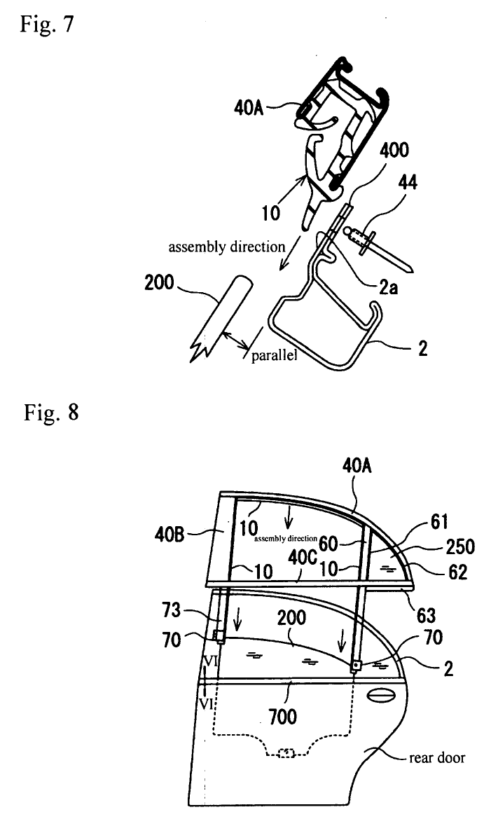

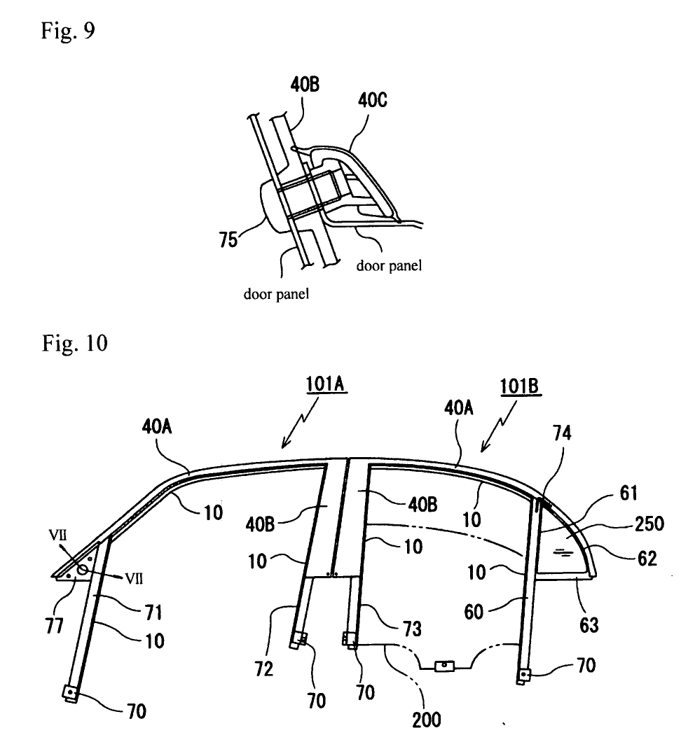

Referring to FIG. 1 to FIG. 9, a method of assembling door parts on an automobile door according to a first embodiment of the present invention will be described. FIG. 1 is a lateral view showing a modularized product 100A, 100B consisting of door parts to be assembled on an automobile door according to a first embodiment of the present invention. FIG. 2 and FIG. 3 are respectively a I-I line enlarged cross section and a II-II line enlarged cross section, showing a state that the modularized product 100A, 100B shown in FIG. 1 is assembled on a door. FIG. 4 to FIG. 6 are respectively a III-III line enlarged cross section, a IV-IV line enlarged cross section and V-V line enlarged cross section of the modularized product 100A, 100B shown in FIG. 1. FIG. 7 and FIG. 8 are lateral views showing the assembly of the door parts. FIG. 9 is a VI-VI line enlarged cross section of FIG. 8. When constituents or items correspond to those in prior arts, the same symbols are used.

The method of assembling the door parts on an automobile door according to a first embodiment is characterized in that a product assembled by modularizing door parts (modularized product) 100A is assembled on a front door with a door sash 2 while a product assembled by modularizing door parts (modularized product) 100B is assembled on a rear door with a door sash 2.

The door parts to be modularized and assembled on the front door mainly include: a glass run 10; a roof molding 40A; a pillar molding 40B on a rear side of the front door; and a decorative belt line molding 40C to be mounted along a belt line 700. In the present embodiment, the door parts to be modularized also include: a glass run channel 71 of which one end is connected with the roof molding 40A on a front side of the front door while the other end extends lower than the belt line 700 and has a fixing part 70 provided on a lower end part thereof for fixing the glass run channel 71 to the front door; and a channel 72 of which one end is connected with a lower end of the pillar molding 40B while the other end extends lower than the belt line 700 and has the fixing part 70 provided on a lower end part thereof for fixing the channel 72 to the front door. However, each of the glass run channel 71 and the channel 72 are not necessarily modularized.

On the other hand, the door parts to be modularized and assembled on the rear door mainly include: the glass run 10; the roof molding 40A; the pillar molding 40B on a front side of the rear door; the belt line molding 40C; a division bar 60; a fixed glass 250; and sealing materials 61, 62 and 63. In the present embodiment, the door parts to be modularized also include a channel 73 of which one end is connected with a lower end of the pillar molding 40B while the other end extends lower than the belt line 700 and has the fixing part 70 provided on a lower end part thereof for fixing the channel 73 to the rear door. However, the channel 73 is not necessarily modularized.

In the same manner as the prior art, the glass run 10 for guiding lifting or lowering of a door glass 200 includes: a cross-section roughly U-shaped installation base member 11 consisting of an outer-cabin side wall 11a, a bottom wall 11b and an inner-cabin side wall 11c; an outer lip 12 formed inward from the outer-cabin side wall 11a of the installation base member 11; and an inner lip 13 formed outward from the inner-cabin side wall 11c of the installation base member 11. The installation base member 11 has a ditch part 20 formed therein for guiding the door glass 200, that is a space enclosed by the outer-cabin side wall 11a, the bottom wall 11b and the inner-cabin side wall 11c. The outer lip 12 and the inner lip 13 are slidably brought into contact with the door glass 200 lifting or lowering.

As shown in FIG. 2, a roof molding 40A made of metal is mounted along the door sash 2 on a roof side. The roof molding 40A covers the roof side from an outer-cabin side and an external appearance exposing part 500 on the outer-cabin side of the roof molding 40A is a decorative surface. On the front door, the roof molding 40A covers the outer-cabin side wall 11a of the glass run 10 from the outer-cabin side. On the rear door, the roof molding 40A covers the outer-cabin side wall 11a of the glass run 10 from the outer-cabin side except for a part on which the fixed glass 250 is mounted. As to the part where the fixed glass 250 is mounted, as shown in FIG. 4, the roof molding 40A covers the sealing material 62 having a rear side slope part of the fixed glass 250 fitted therein from the outer-cabin side.

As shown in FIG. 3, a pillar molding 40B made of metal is mounted along the door sash 2 on a pillar side. The pillar molding 40B covers the pillar side from the outer-cabin side and the external appearance exposing part 500 on the outer-cabin side of the pillar molding 40B is the decorative surface. The pillar molding 40B covers the outer-cabin side wall 11a of the glass run 10 from the outer-cabin side both on the front door and the rear door.

In the Figs., the roof molding 40A and the pillar molding 40B are painted in black.

Each of the roof molding 40A and the pillar molding 40B are integrally molded with a cross-section roughly U-shaped channel part 41 having the installation base member 11 of the glass run 10 fitted therein. That is, the channel part 41 is a little larger than the cross-section roughly U-shaped installation base member 11 of the glass run 10 and has the glass run 10 assembled therein making use of elasticity of the glass run 10.

As shown in FIG. 2, an inner-cabin side of the roof molding 40A is fixed to a flange 400 extending from the door sash 2 to an upper side by means of a caulking pin 44. The roof molding 40A is assembled on an outer-cabin side of a mounting surface 2a of the door sash 2, formed roughly in parallel with a surface of the door glass 200. On the other hand, as shown in FIG. 3, a bottom wall side of the channel part 41 of the pillar molding 40B is fixed to the door sash 2 by means of an attaching screw 45. The pillar molding 40B is assembled on the outer-cabin side of the mounting surface 2a of the door sash 2, formed roughly in parallel with the surface of the door glass 200.

The division bar 60 forming a boundary between the door glass 200 and the fixed glass 250 includes: a division channel 65 having cross-section roughly U-shaped channel parts formed both on the front side and the rear side thereof, the glass run 10 which is provided with the lips slidably brought into contact with the door glass and fitted on the front side of the division channel 65; and the sealing material 61 which is fitted on the rear side of the division channel 65 and has a front end of the fixed glass 250 fitted therein.

The fixed glass 250 has a roughly triangle shape and is fixed to a rear corner part of the rear door by means of the sealing materials 61, 62 and 63, provided around circumference of the fixed glass 250. As shown in FIG. 4, the front end of the fixed glass 250 is fixed on a division bar 60 side by means of the sealing material 61 provided on the rear side of the division bar 60 whereas the rear side slope part of the fixed glass 250 is fixed on the rear side of the roof molding 40A, more specifically, the rear side slope part of the fixed glass 250 is fixed on the roof molding 40A side by means of the sealing material 62 provided on a rear side compared with a point where an upper end part of the division bar 60 is connected with the roof molding 40A. In addition, as shown in FIG. 6, a lower end of the fixed glass 250 is fitted in the sealing material 63 and is fixed on the belt line molding 40C side by means of a resin insert 64 embedded in said sealing material 63. Although the present embodiment shows the use of the resin insert 64, the present invention is not limited to such a connecting member and any methods of connecting the sealing material 63 and the belt line molding 40C are applicable.

Assembling force of the glass run 10 to the molding member 40 is increased by fitting an anchoring lip 14 provided on an outer side of the inner-cabin side wall 11c of the glass run 10 into a concave part 43 formed between the door sash 2 and an inner-cabin side end part 42 of the roof molding 40A or the pillar molding 40B. The concave part 43 may be formed by bending the door sash 2 to the inner-cabin side compared with the inner-cabin side end part 42 of the straight-lined roof molding 40A as shown in FIG. 2 or by bending the inner-cabin side end part 42 of the pillar molding 40B to the outer-cabin side compared with the door sash 2 as shown in FIG. 3.

On the roof side, anchoring parts 46 are formed by bending the upper side of the roof molding 40A, that is, the upper side on a bottom wall side of the channel part 41. The anchoring parts 46 anchor to an installation base member 3a of a drip seal 3 which makes an elastic contact with a body panel 300 when the door is closed. An installation base member of a weather strip 4 is formed on the upper side of the door sash 2. The weather strip 4 makes the elastic contact with the body panel 300 when the door is closed. The drip seal 3 and the weather strip 4 are integrally molded.

Said door parts assembled in the above-mentioned manner can be provided as the modularized product prior to a vehicle assembly line in which the modularized product is assembled on the automobile door.

The modularized product 100A for use on the front door is assembled by: connecting an upper end part of said pillar molding 40B formed by fitting the glass run 10 into the cross-section roughly U-shaped channel part 41 to the rear end of the roof molding 40 A formed by fitting the glass run 10 into the cross-section roughly U-shaped channel part 41; connecting the belt line molding 40C both to the front end part of the roof molding 40A and the lower end part of the pillar molding 40B; connecting the glass run channel 71 to the roof molding 40A at the front side of the front door; and connecting the channel 72 to the lower end of the pillar molding 40B.

The modularized product 100B for use on the rear door is assembled by: fitting the rear side slope part of the fixed glass 250 into the sealing material 62 provided on the rear side of the roof molding 40A formed by fitting the glass run 10 into the cross-section roughly U-shaped channel part 41; connecting the upper end part of the division bar 60 to the roof molding 40A while fitting the front end of the fixed glass 250 into the sealing material 61 on the rear side of the division bar 60 having the glass run 10 mounted on the front side thereof, connecting the upper end part of the pillar molding 40B formed by fitting the glass run 10 into the cross-section roughly U-shaped channel part 41 to the front end of the roof molding 40 A; connecting the belt line molding 40C both to the rear end part of the roof molding 40A and the lower end part of the pillar molding 40B; connecting the sealing material 63 having the lower end of the fixed glass 250 fitted thereon to the belt line molding 40C by means of the resin insert 64; and connecting the channel 73 to the lower end of the pillar molding 40B.

The sealing material 61 may be fitted on a front end of the fixed glass 250 prior to assembling the sealing material 61 on the rear side of division bar 60 whereas the sealing material 61 may also be assembled on the rear side of division bar 60 prior to fitting the front end of the fixed glass 250. The sealing material 62 may be fitted on the rear side slope part of the fixed glass 250 prior to assembling the sealing material 62 on the roof molding 40A whereas the sealing material 62 may also be assembled on the roof molding 40A prior to fitting the rear side slope part of the fixed glass 250. The sealing material 63 may be fitted on the lower end of the fixed glass 250 prior to assembling the sealing material 63 on the belt line molding 40C whereas the sealing material 63 may also be assembled on the belt line molding 40C prior to fitting the lower end of the fixed glass 250.

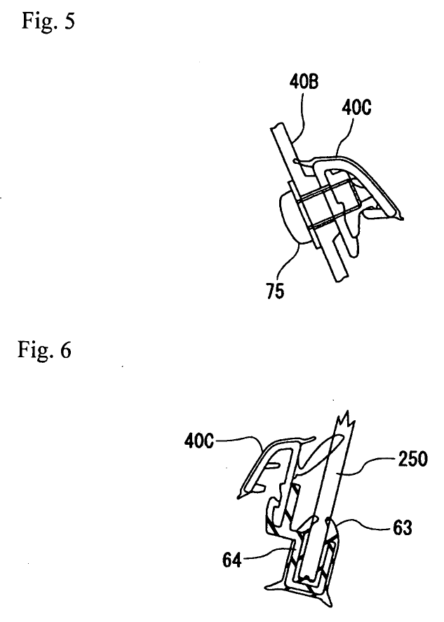

Boundaries between each of the moldings 40A, 40B and 40C; the moldings 40A, 40B and the channels 71, 72, 73; and the molding 40A and the division bar 60 are connected by a connecting member 74 shown in FIG. 1, a screw 75 shown in FIG. 5 or a clip. The boundaries may also be directly connected by welding.

Then, the modularized product 100A for use on the front door and the modularized product 100B for use on the rear door, which are respectively assembled in a manner shown in FIG. 1 are referred to the vehicle assembly line.

On the front door side, the modularized product 100A is assembled on the front door by fitting the roof molding 40A, the pillar molding 40B and the belt line molding 40C of the modularized product 100A along the door sash 2 and the belt line 700 of the front door in the vehicle assembly line. More specifically, the roof molding 40A, the pillar molding 40B and the belt line molding 40C are fitted respectively along the roof side of the door sash 2, the pillar side of the door sash 2 and the belt line 700 of the front door by means of fastening tools including a nail, the screw, a caulking pin and the clip. In addition, fixing parts 70 provided on the glass run channel 71 and the channel 72 are fixed to the front door.

Lastly, the door glass 200 is inserted into the front door panel so as to complete the assembly. The door glass 200 may also be inserted into the front door panel prior to pressing down the modularized product 100A from the upper side of the door glass 200.

On the other hand, on the rear door side, the door glass 200 is inserted into the rear door panel at the beginning of the vehicle assembly line.

Then, as shown in FIG. 7 and FIG. 8, the modularized product 100B is pressed down from the upper side of the door glass 200 so that the upper part of the door glass 200 inserted into the rear door panel is inserted into the glass run 10 on the roof side. And then, the modularized product 100B is assembled on the rear door by fitting the roof molding 40A, the pillar molding 40B and the belt line molding 40C of the modularized product 100B along the door sash 2 and the belt line 700. More specifically, the roof molding 40A, the pillar molding 40B and the belt line molding 40C are fitted respectively along the roof side of the door sash 2, the pillar side of the door sash 2 and the belt line 700 of the rear door by means of the fastening tools including the nail, the screw, the caulking pin and the clip. The screw 75, fixing the boundary between the pillar molding 40B and the belt line molding 40C as shown in FIG. 5, further fixes said boundary to the door panel as shown in FIG. 9.

In the assembly of the modularized product 100B, as shown in FIG. 7, the roof molding 40A is assembled on an outer-cabin side of a mounting surface 2a of the door sash 2 by fixing the roof molding 40A to a flange 400 extending from the mounting surface 2a of the door sash 2, formed roughly in parallel with a surface of the door glass 200 by means of the caulking pin 44 from the inner-cabin side. The pillar molding 40B side may have the same structure as roof molding 40A side. Further, the fixing part 70 provided on the lower end of the division bar 60 and the fixing part 70 provided on the channel 73 are also fixed to the rear door so as to complete the assembly.

According to the method of assembling the door parts on an automobile door of the present invention, the door parts including: the roof molding 40A; the pillar molding 40B; the belt line molding 40C; the division bar 60; the sealing materials 61, 62 and 63; and the fixed glass 250 to be assembled on the front door with the sash or the rear door with the sash are assembled into the modularized product 100A, 100B prior to the vehicle assembly line. Therefore, unevenness in any of the parts, detected in a connecting operation of the parts, can be adjusted prior to the vehicle assembly line. As a result, in the vehicle assembly line, adjustment of the unevenness in any of the parts is unnecessary so that the modularized product excellent in appearance can be easily selected and assembled on the door panel.

In addition, the assembly of the modularized product, carried out in the final vehicle assembly line, enables streamlined assembly of the door parts so that even an unskilled operator can easily carry out the assembly.

Apart from the door panel, the roof molding 40A and the pillar molding 40B are modularized to provide a part of which external appearance exposing part 500 as a decorative surface can be freely luster painted in harmony with design of an automobile body. In addition, the use of the roof molding 40A and the pillar molding 40B, which are made of metal excellent in rigidity and weatherability results in improved durability. In addition, luster peculiar to the metal demonstrates unique decorativeness.

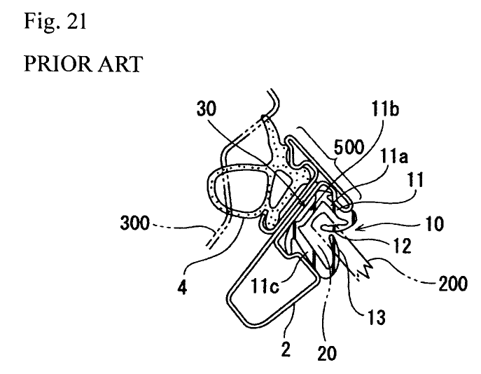

As shown in FIG. 21, an ordinary method of assembling door parts on a rear door has comprised the steps of: assembling the door glass 200 in the door panel prior to assembling the glass run 10; and forcedly inserting the glass run 10 from an upper side of the door glass 200 into the channel part 30 of the door sash 2. On the other hand, according to the method of assembling the door parts on the rear door of the first embodiment of the present invention, as shown in FIG. 7, the glass run 10 is fitted into the roof molding 40A prior to the vehicle assembly line so that only the assembly of the roof molding 40A having the glass run 10 fitted therein on the outer-cabin side of the mounting surface 2a of the door sash 2 is required at the time of the vehicle assembly line. Therefore, an excessive force is not needed and even the unskilled operator can easily carry out the assembly.

Each of the roof molding 40A and the pillar molding 40B are integrally molded with the cross-section roughly U-shaped channel part 41 having the installation base member 11 of said glass run 10 fitted therein. Therefore, periphery of the glass run 10 is covered with the roof molding 40A or the pillar molding 40B and the glass run 10 is firmly assembled with the roof molding 40A or the pillar molding 40B.

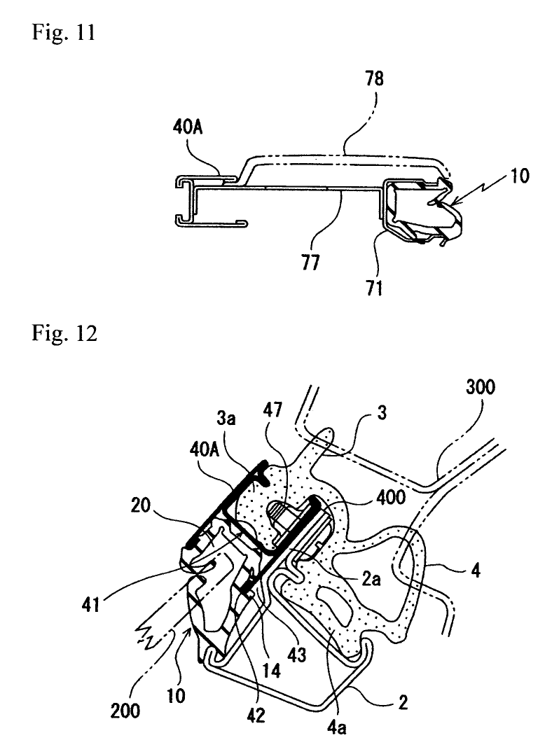

A method of assembling door parts on another automobile door, according to a first embodiment of the present invention will be described hereinafter. According to the method, modularized products 101A and 101B, neither of which includes a belt line molding 40C, as shown in FIG. 10, are provided and then they are referred to a vehicle assembly line. FIG. 11 is a VII-VII line enlarged cross section of FIG. 10.

In order to stable a shape of the modularized products 101A, the modularized product 101A includes a connecting member 77 connecting the roof molding 40A and the glass run channel 71 by the surface. Numeral 78 shows a cover for a door mirror.

On a front door side, the method of assembling the door parts on another automobile door, according to the first embodiment comprises the steps of connecting an upper end part of a pillar molding 40B having a glass run 10 fitted therein to a rear end of a roof molding 40 A having the glass run 10 fitted therein, thereby assembling the modularized product 101A in advance; and assembling the modularized product 101A on the front door by fitting the roof molding 40 A and the pillar molding 40B along the door sash 2 and inserting the door glass 200 into the front door panel in the vehicle assembly line.

Alternatively, the door glass 200 may also be inserted into the door panel prior to pressing down the modularized product 101A from the upper side of the door glass 200 and assembling the modularized product 101A on the front door.

On the other hand, on a rear door side, the method of assembling the door parts on another automobile door, according to the first embodiment comprises the steps of fitting a rear side slope part of a fixed glass 250 into a sealing material 62 provided on a rear side of the roof molding 40A having the glass run 10 fitted therein, connecting an upper end part of a division bar 60 to the roof molding 40A while fitting a front end of the fixed glass 250 into a sealing material 61 on a rear side of the division bar 60 having the glass run 10 provided on the front side thereof, and connecting the upper end part of the pillar molding 40B having the glass run 10 fitted therein to the front end of the roof molding 40A, thereby assembling the modularized product 101B in advance; and, in a vehicle assembly line, inserting the door glass 200 into the rear door panel, pressing down the modularized product 101B from the upper side of the door glass 200 so as to insert an upper part of said door glass 200 into the glass run 10 on the roof side and assembling the modularized product 101B on the rear door by fitting the roof molding 40 A and the pillar molding 40B along the door sash 2.

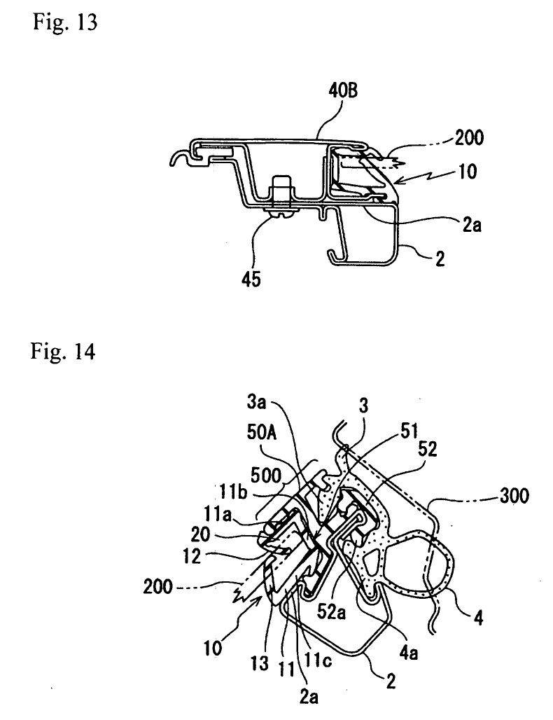

Although the present embodiment describes an example that the inner-cabin side of the channel part 41 formed on the roof molding 40A is fixed to the flange 400 extending from the door sash 2 by means of the caulking pin 44 as shown in FIG. 2, the present invention is not limited to said embodiment. Modifications of said embodiment include fixing a drip seal 3 side of the roof molding 40A to the flange 400 extending from the door sash 2 by means of an attaching screw 47 as shown in FIG. 12. In addition, the present embodiment describes an example that the pillar molding 40B is fixed to a slope on door sash 2 by means of an attaching screw 45 as shown in FIG. 3. Modifications of said embodiment also include fixing the pillar molding 40B to the mounting surface 2a of the door sash 2, formed roughly in parallel with the door glass 200 by means of the attaching screw 45 as shown in FIG. 13.

### Second Embodiment

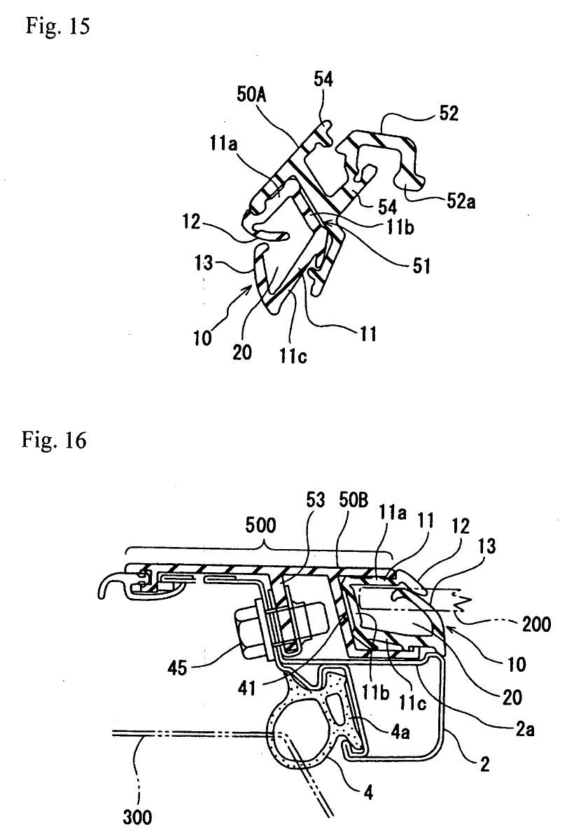

Referring to FIG. 14 to FIG. 16, a method of assembling door parts on an automobile door, according to a second embodiment of the present invention will be described. FIG. 14 and FIG. 16 are respectively a I-I line enlarged cross section and a II-II line enlarged cross section, showing a state that a modularized product consisting of the door parts to be assembled on an automobile door, according to the second embodiment of the present invention is assembled on a door; and FIG. 15 is an enlarged cross section showing important parts of the door parts to be assembled on an automobile door of FIG. 14. When constituents or items correspond to those in the prior arts, the same symbols are used.

The method of assembling the door parts on an automobile door, according to the second embodiment of the present invention is characterized in that a glass run 10 is mounted on the door sash 2 by means of a roof molding 50A or a pillar molding 50B, which are made of resin. The present embodiment employs: the roof molding 50A made of resin instead of the roof molding 40A made of metal of the first embodiment; and the pillar molding 50B made of resin instead of the pillar molding 40B made of metal of the first embodiment.

The roof molding 50A and the pillar molding 50B respectively cover an outer-cabin side wall 11a of the glass run 10 from an outer-cabin side and an external appearance exposing part 500 which is an outer-cabin side of the roof molding 50A and the pillar molding 50B is a decorative surface.

Each of the roof molding 50A and the pillar molding 50B, in the same manner as the roof molding 40A and the pillar molding 40B of the first embodiment, are integrally molded with a cross-section roughly U-shaped channel part 51 having an installation base member 11 of the glass run 10 fitted therein. That is, the channel part 51 is a little larger than the cross-section roughly U-shaped installation base member 11 of the glass run 10 and has the glass run 10 assembled therein making use of elasticity of the glass run 10.

As shown in FIG. 14 and FIG. 15, the roof molding 50A is fixed to a flange 400 extending from a door sash 2 to an upper side by clasping the roof molding 50A and the flange 400 by means of a cross-section roughly U-shaped grip 52 integrally molded with an upper cabin side of the roof molding 50A. The grip 52 has a projection 52a formed on an end thereof. A cabin side of the projection 52a anchors to an installation base member 4a of a weather strip 4 which is installed on the door sash 2 and makes an elastic contact with a body panel 300 when the door is closed. Such a structure causes pressuring force of the weather strip 4 to be transmitted from an outer-cabin side of the projection 52a of the grip 52 to the flange 400 on which the projection 52a abuts, thereby increasing assembling force of the grip 52 for clasping the molding member 50 and the flange 400.

In addition, as shown in FIG. 16, an elongated part 53 extending from the pillar molding 50B is fixed to the door sash 2 by means of the attaching screw 45.

Further, anchoring parts 54 are formed on the upper side of the roof molding 50A, that is, they are formed on an outer-cabin side and an inner-cabin side on an upper side of a bottom wall of the channel part 51. The anchoring parts 54 anchor to the installation base member 3a of the drip seal 3 which makes the elastic contact with the body panes 300 when the door is closed. The drip seal 3 and the weather strip 4 are integrally molded.

According to the present embodiment, the roof molding 50A and the pillar molding 50B are integrally molded with the cross-section roughly U-shaped channel part 51 having the installation base member 11 of the glass run 10 fitted therein. Therefore, periphery of the glass run 10 is covered with the roof molding 50A or the pillar molding 50B and the glass run 10 is firmly assembled with the roof molding 50A or the pillar molding 50B. In addition, the roof molding 50A and the pillar molding 50B can easily separate from the door sash 2. Therefore, the roof molding 50A and the pillar molding 50B can be painted, for example, on parts makers' end and colors painted on the roof molding 50A and the pillar molding 50B can be freely selected.

Further, in the second embodiment, since the roof molding 50A and the pillar molding 50B are made of resin, productivity is improved as well as downsizing because the roof molding 50A and the pillar molding 50B made of resin can be set up the same color as the glass run 10 so that further painting is not required.

Furthermore, the integral molding of the inner-cabin side of the roof molding 50A with the grip 52 for installing the roof molding 50A on the flange 400 formed on the door sash 2 results in the improved productivity and the increased assembling force because producing and mounting the grip 52 as an extra part becomes unnecessary.

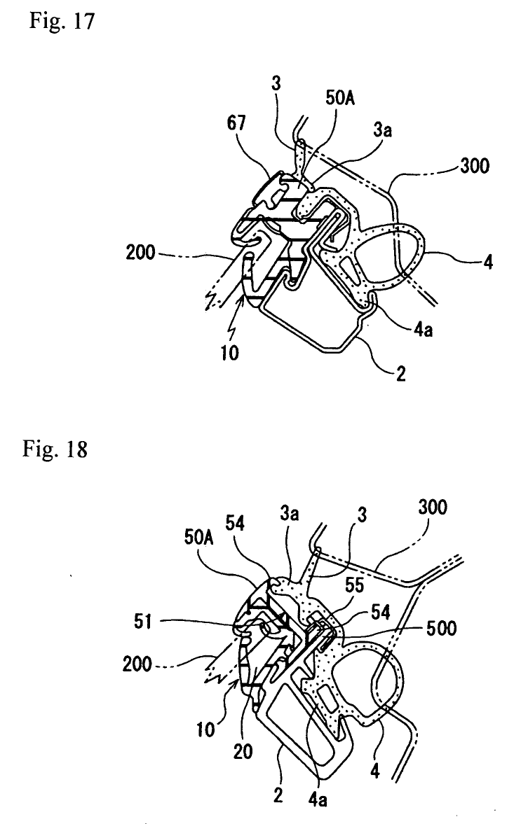

Although the present embodiment shows the assembly of the roof molding 50A and the glass run 10, which are respectively and separately formed, the roof molding 50A and the glass run 10 may be integrally extrusion-molded as shown in FIG. 17. The pillar molding 50B may also be integrally extrusion-molded with the glass run 10. In addition, although FIG. 17 shows an example that an extra molding 67 is installed on an outer-cabin side of an integrally molded product of the roof molding 50A and the glass run 10, the molding 67 is not necessarily installed.

Said structure results in further improved productivity because assembling the roof molding 50A with the glass run 10 or the pillar molding 50B with the glass run 10 becomes unnecessary.

In addition, the roof molding 50A may be installed on an aluminum door sash 2 by means of a metal clip 55 as shown in FIG. 18. Specifically, the anchoring part 54 formed on the upper cabin side of the roof molding 50A is piled on the flange 400 extending from the door sash 2 to the upper side and the metal clip 55 fastens the anchoring part 54 and the flange 400. The use of the metal clip 55 has an advantage that preparation of a hole for mounting the clip on the roof molding 50A is unnecessary.

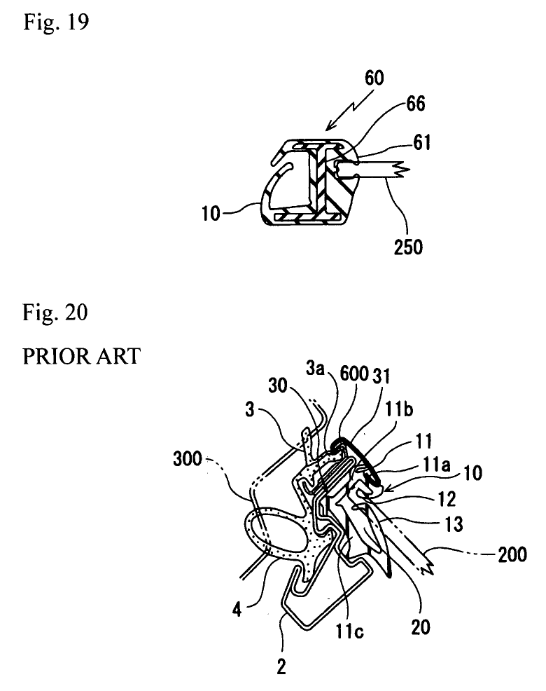

Although the present embodiment shows the use of the division bar 60 having the glass run 10 and the sealing material 61 respectively fitted on the front side and the rear side thereof as shown in FIG. 4, the present invention is not limited to said embodiment. Modifications of the division bar 60 include an integrally molded product of the glass run 10 and the sealing material 61 having a hard resin 66 embedded therein as shown in FIG. 19.

The present embodiment is intended for use on an automobile having the division bar 60, the fixed glass 250 and the sealing member 61 provided on the rear door thereof. In case FIG. 1 of the present embodiment is applied to an automobile without the division bar 60, the fixed glass 250 and the sealing member 61, a modularized product 100B is assembled in advance by connecting an upper end part of the pillar molding 40B, 50B having the glass run 10 fitted therein to a front end part of said roof molding 40A, 50A having the said glass run 10 fitted therein and connecting a belt line molding 40C both to a rear end part of the roof molding 40A, 50A and a lower end part of the pillar molding 40B, 50B. In case FIG. 10 of the present embodiment is applied to the automobile without the division bar 60, the fixed glass 250 and the sealing member 61, a modularized product 101B is assembled in advance by connecting the upper end part of the pillar molding 40B, 50B having the glass run 10 fitted therein to the front end part of said roof molding 40A, 50A having the said glass run 10 fitted therein. Then, in the vehicle assembly line, the modularized product 100B, 101B without the division bar 60, the fixed glass 250 and the sealing member 61 is pressed down from the upper side of the door glass 200 after inserting the door glass 200 into the rear door panel so that the upper part of the door glass 200 is inserted into the glass run 10 on the roof side and the modularized product 100B, 101B is assembled on the rear door along the belt line 700 and the door sash 2.

1. A method of assembling door parts on a front door with a sash, said door parts including: a glass run mounted on a roof side and a pillar side, which has a ditch part formed therein for guiding lifting or lowering of a door glass and provided with lips slidably brought into contact with the door glass; a decorative roof molding covering said roof side from an outer-cabin side; a decorative pillar molding covering said pillar side from the outer-cabin side; and a decorative belt line molding to be mounted along a belt line, comprising the steps of:
connecting an upper end part of said pillar molding having said glass run mounted therein to a rear end part of said roof molding having said glass run mounted therein and connecting said belt line molding both to a front end part of said roof molding and a lower end part of said pillar molding, thereby assembling a modularized product in advance; and
assembling said modularized product on the front door by fitting the roof molding and the pillar molding along the door sash and the belt line molding along the belt line in a vehicle assembly line.

2. A method of assembling door parts on a front door with a sash, said door parts including: a glass run mounted on a roof side and a pillar side, which has a ditch part formed therein for guiding lifting or lowering of a door glass and provided with lips slidably brought into contact with the door glass; a decorative roof molding covering said roof side from an outer-cabin side; and a decorative pillar molding covering said pillar side from the outer-cabin side, comprising the steps of:
connecting an upper end part of said pillar molding having said glass run mounted therein to a rear end part of said roof molding having said glass run mounted therein, thereby assembling a modularized product in advance; and
assembling said modularized product on the front door by fitting the roof molding and the pillar molding along the door sash in a vehicle assembly line.

3. A method of assembling door parts on a rear door with a sash, said door parts including: a glass run mounted on a roof side and a pillar side, which has a ditch part formed therein for guiding lifting or lowering of a door glass and provided with lips slidably brought into contact with the door glass; a decorative roof molding covering said roof side from an outer-cabin side; a decorative pillar molding covering said pillar side from the outer-cabin side; and a decorative belt line molding to be mounted along a belt line, comprising the steps of:
connecting an upper end part of said pillar molding having said glass run mounted therein to a front end part of said roof molding having said glass run mounted therein and connecting said belt line molding both to a rear end part of said roof molding and a lower end part of said pillar molding, thereby assembling a modularized product in advance; and
inserting the door glass into a panel of said rear door, pressing down the modularized product from an upper side of the door glass so as to insert an upper part of said door glass into the glass run on the roof side and assembling the modularized product on the rear door by fitting the belt line molding along the belt line and the roof molding and the pillar molding along the door sash in a vehicle assembly line.

4. A method of assembling door parts on a rear door with a sash, said door parts including: a glass run mounted on a roof side and a pillar side, which has a ditch part formed therein for guiding lifting or lowering of a door glass and provided with lips slidably brought into contact with the door glass; a decorative roof molding covering said roof side from an outer-cabin side; and a decorative pillar molding covering said pillar side from the outer-cabin side, comprising the steps of:
connecting an upper end part of said pillar molding having said glass run mounted therein to a front end part of said roof molding having said glass run mounted therein, thereby assembling a modularized product in advance; and
inserting the door glass into a panel of said rear door, pressing down the modularized product from an upper side of the door glass so as to insert an upper part of said door glass into the glass run on the roof side and assembling the modularized product on the rear door by fitting the roof molding and the pillar molding along the door sash in a vehicle assembly line.

5. The method of assembling the door parts on an automobile door as claimed in claim 1, wherein:
said glass run includes a cross-section roughly U-shaped installation base member consisting of an outer-cabin side wall, a bottom wall and an inner-cabin side wall;
each of said roof molding and said pillar molding are integrally molded with a cross-section roughly U-shaped channel part having the installation base member of said glass run fitted therein; and
said roof molding and said pillar molding are assembled on an outer-cabin side of a mounting surface of the door sash, formed roughly in parallel with a surface of the door glass, in an assembly of said modularized product.

6. The method of assembling the door parts on an automobile door as claimed in claim 1, wherein:
said roof molding and said pillar molding are made of metal.

7. The method of assembling the door parts on an automobile door as claimed in claim 1, wherein:
said roof molding and said pillar molding are made of resin.

8. (canceled)

9. The method of assembling the door parts on an automobile door as claimed in claim 2, wherein:
said glass run includes a cross-section roughly U-shaped installation base member consisting of an outer-cabin side wall, a bottom wall and an inner-cabin side wall;
each of said roof molding and said pillar molding are integrally molded with a cross-section roughly U-shaped channel part having the installation base member of said glass run fitted therein; and
said roof molding and said pillar molding are assembled on an outer-cabin side of a mounting surface of the door sash, formed roughly in parallel with a surface of the door glass, in an assembly of said modularized product.

10. The method of assembling the door parts on an automobile door as claimed in claim 3, wherein:
said glass run includes a cross-section roughly U-shaped installation base member consisting of an outer-cabin side wall, a bottom wall and an inner-cabin side wall;
each of said roof molding and said pillar molding are integrally molded with a cross-section roughly U-shaped channel part having the installation base member of said glass run fitted therein; and
said roof molding and said pillar molding are assembled on an outer-cabin side of a mounting surface of the door sash, formed roughly in parallel with a surface of the door glass, in an assembly of said modularized product.

11. The method of assembling the door parts on an automobile door as claimed in claim 4, wherein:
said glass run includes a cross-section roughly U-shaped installation base member consisting of an outer-cabin side wall, a bottom wall and an inner-cabin side wall;
each of said roof molding and said pillar molding are integrally molded with a cross-section roughly U-shaped channel part having the installation base member of said glass run fitted therein; and
said roof molding and said pillar molding are assembled on an outer-cabin side of a mounting surface of the door sash, formed roughly in parallel with a surface of the door glass, in an assembly of said modularized product.

12. The method of assembling the door parts on an automobile door as claimed in claim 2, wherein:
said roof molding and said pillar molding are made of metal.

13. The method of assembling the door parts on an automobile door as claimed in claim 3, wherein:
said roof molding and said pillar molding are made of metal.

14. The method of assembling the door parts on an automobile door as claimed in claim 4, wherein:
said roof molding and said pillar molding are made of metal.

15. The method of assembling the door parts on an automobile door as claimed in claim 2, wherein:
said roof molding and said pillar molding are made of resin.

16. (canceled)

17. The method of assembling the door parts on an automobile door as claimed in claim 3, wherein:
said roof molding and said pillar molding are made of resin.

18. (canceled)

19. The method of assembling the door parts on an automobile door as claimed in claim 4, wherein:
said roof molding and said pillar molding are made of resin.

20. (canceled)

21. The method of assembling the door parts on an automobile door as claimed in claim 5, wherein:
said roof molding and said pillar molding are made of metal.

22. The method of assembling the door parts on an automobile door as claimed in claim 9, wherein:
said roof molding and said pillar molding are made of metal.

23. The method of assembling the door parts on an automobile door as claimed in claim 10, wherein:
said root molding and said pillar molding are made of metal.

24. The method of assembling the door, parts on an automobile door as claimed in claim 11, wherein:
said roof molding and said pillar molding are made of metal.

25. The method of assembling the door parts on an automobile door as claimed in claim 5, wherein:
said roof molding and said pillar molding are made of resin.

26. The method of assembling the door parts on an automobile door as claimed in claim 9, wherein:
said roof molding and said pillar molding are made of resin.

27. The method of assembling the door parts on an automobile door as claimed in claim 10, wherein:
said roof molding and said pillar molding are made of resin.

28. The method of assembling the door parts on an automobile door as claimed in claim 11, wherein:
said roof molding and said pillar molding are made of resin.
